(19) United States
(12) Patent Application Publication
(10) Pub. No.: US 2023/0258571 A1
(43) Pub. Date: Aug. 17, 2023

(54) TESTING OF CENTRAL HEATING SYSTEM WATER

(71) Applicant: Adey Holdings (2008) Limited, Haresfield, Stonehouse (GB)

(72) Inventors: Mo Jassal, Haresfield, Stonehouse (GB); Hannah Blandon, Haresfield, Stonehouse (GB); Dan Bacon, Haresfield, Stonehouse (GB); James Foot, Haresfield, Stonehouse (GB); Natacha Ruby, Haresfield, Stonehouse (GB); Andy Farmer, Haresfield, Stonehouse (GB)

(21) Appl. No.: 18/041,127

(22) PCT Filed: Jul. 2, 2021
(86) PCT No.: PCT/EP2021/068300

§ 371 Date: Feb. 9, 2023

(30) Foreign Application Priority Data
Aug. 11, 2020 (GB) 2012454.1

(51) Int. Cl. G01N 21/84; G01N 31/22

(52) U.S. Cl. CPC G01N 21/8483; G01N 31/22

(57) ABSTRACT

A method of testing central heating system water for concentration of molybdate corrosion inhibitor is disclosed. The method comprises use of a dip test pad to test for iron concentration, and use of a dip test pad to test for molybdate concentration. In assessment of the dip test pad to test for molybdate concentration, the assessed iron level is taken into account. This leads to a more accurate and reliable result than is realised with known dip test.

The present invention relates to the testing of central heating system water, in particular to ensure that corrosion inhibitor is present in the correct quantity.

### BACKGROUND TO THE INVENTION

It is known to test central heating and/or cooling system water for the presence and concentration of a variety of different chemicals. For example, known colour-change “dip tests” can be used to measure the pH of the water, and the concentration of iron, copper, and a corrosion inhibitor. Typically a corrosion inhibitor contains molybdate, and the molybdate concentration is used to determine whether inhibitor is present in the correct quantity in the system water.

A “dip test” is in the form of a pad impregnated with a reagent, which in turn is mounted on a stick to act as a carrier. The pad is dipped in a sample of the liquid to be tested, and the impregnated pad then changes colour. The colour of the pad can be compared to a reference to determine the concentration of the particular chemical being tested for, the pH value, etc.

The applicant's co-pending application GB2576942 describes methods for digital assessment of such dip tests, for example using a mobile phone with a camera to take a picture of the dipped test alongside a colour reference scale, and determining the level of various chemicals being tested for according to a comparison between the colour of the dipped test and the colour reference scale, and stored information mapping points on the colour reference scale to amounts of chemical indicated.

However, due to the variety of chemicals which may be found in central heating system water, and the interactions of different chemicals with the colour-change reagents, it has proved to be particularly difficult to use colour change “dip tests” to get a reliably accurate measurement of molybdate in central heating system water. It is an object of the invention to solve this problem.

### SUMMARY OF THE INVENTION

According to the present invention, there is provided a method of testing central heating and/or cooling system water for the concentration of molybdate, comprising the steps of:
using a first colour-change dip test to test for the concentration of iron in the central heating and/or cooling system water, and comparing the colour of the first colour-change dip test to an iron testing reference to assess an iron concentration;
using a second colour-change dip test to test for the concentration of molybdate in the central heating and/or cooling system water, and comparing the colour of the second colour-change dip test to a molybdate testing reference, and assessing the molybdate concentration based on the comparison of the second dip test to the reference, and the assessed concentration of iron.

It is found that colour-change dip tests can be used reliably to determine the concentration of iron in central heating system water. Iron is a common contaminant in central heating system water, but can be present in widely varying concentrations depending on the size, age, type, and condition of the central heating system. Varying concentrations of iron have an effect on the colour of a molybdate dip test, but by testing for and assessing iron concentration and then taking the assessed level of iron concentration into account when assessing molybdate concentration, it is found that an accurate result can be obtained.

In one embodiment, multiple colour reference scales are provided for use in the comparison of the second dip test. If iron concentration is assessed within a first range, then the second colour-change dip test may be compared to a first colour reference scale, and if iron concentration is assessed within a second range, then the second colour-change dip test may be compared to a second colour reference scale. In some embodiments, there may be three or more colour reference scales for assessment of molybdate, each colour reference scale corresponding with a particular range of values of assessed iron concentration.

In an alternative embodiment, a single colour reference scale may form the molybdate testing reference, but the mapping of assessed values for the concentration of molybdate onto the colour reference scale may be altered according to the assessed iron concentration.

Preferably, the first colour-change dip test and the second colour-change dip test may be provided as first and second pads on the same carrier. The carrier may be for example an elongate stick, which may be made from plastics or another water-resistant material. Preferably, one or more absorbent buffer pads may be provided between the first and second pads. This reduces the possibility of colour-change reagent bleeding from one pad to the other when the pads are withdrawn from a test sample.

Suitable colour reference scales may be derived by the skilled person, by making up multiple samples with known iron and molydbate concentrations, carrying out dip tests using dip test pads impregnated with suitable reagents, and deriving colour reference scales for multiple iron concentration ranges. In one embodiment, a different colour reference scale for assessment of the molybdate dip test is provided for each of the following ranges of iron concentration:

if iron concentration assessed at ≥0 ppm and <5 ppm, a first molybdate colour reference scale is used;

if iron concentration assessed at ≥5 ppm and <10 ppm, a second molybdate colour reference scale is used;

if iron concentration assessed at ≥10 ppm and <20 ppm, a third molybdate colour reference scale is used; and

if iron concentration assessed at ≥20 ppm, a fourth molybdate colour reference scale is used.

Multiple molybdate assessment colour reference scales, together with an iron testing colour reference scale, may be provided on a single colour reference card.

Preferably, the assessment of iron level and assessment of molybdate level may be carried out by way of a photograph of the dip tests next to the colour reference scales, by digital assessment apparatus for example as disclosed in GB2576942.

### DESCRIPTION OF THE DRAWING

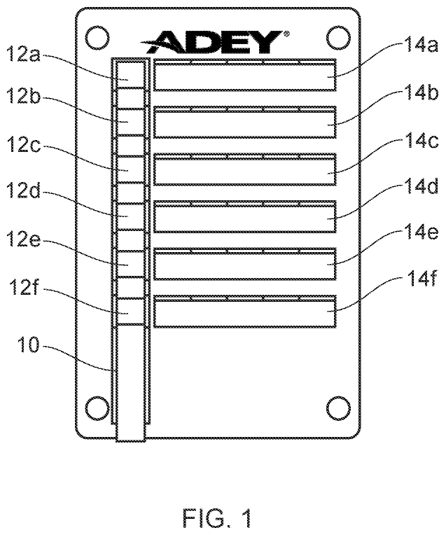

For a better understanding of the invention, and to show more clearly how it may be carried into effect, a preferred embodiment will now be described with reference to the drawing, FIG. 1, which shows a dip testing carrier including multiple dip testing pads, alongside a colour reference card comprising multiple colour reference scales.

### DESCRIPTION OF THE PREFERRED EMBODIMENT

Referring to FIG. 1, a carrier in the form of a plastic stick is indicated at 10. The carrier includes six colour-change dip test pads 12a, 12b, 12c, 12d, 12e, 12f. The carrier, and all the colour-change dip test pads, are dipped into a sample of central heating and/or cooling system water to be tested.

The carrier with six colour-change dip test pads is obtained from Precision Laboratories, Inc of Cottonwood, Ariz. 86326, USA. The dip test pads are treated with colour-change reagents designed to be sensitive to molybdate, copper, and iron, as well as three pads with different reagents designed to be sensitive to pH.

Not all of the dip test pads on this particular six-pad carrier are used directly to assess water properties in this embodiment. However, the molybdate and iron testing pads are not adjacent, and the pad in between in practice forms a buffer which prevents leaching of colour-change reagent from the molybdate pad. In another embodiment, the “buffer” pad of course does not need to be treated with any reagent itself.

The carrier 10 is shown pictured in position on a colour reference card. The colour reference card includes multiple colour reference scales 14a, 14b, 14c, 14d, 14e, 14f. Although each reference scale is shown in the drawing adjacent a particular pad, the reference scales are not necessarily used in the assessment to assess the pad which is placed adjacent to them. Since the assessment is preferably carried out by software running on a mobile device, as described in GB2576942, it does not matter that there is not an obvious correspondence between the scale being used for assessment and the pad being assessed.

Note also that there are no numbers or other references marked on the scale, since the scales are designed for use with software which will include further reference information, allowing the colour comparison with the reference card to be used to assess a quantity of chemical present.

In another embodiment, assessment may be carried out “by eye”, in which case it would be expected that numerical reference information and clear instructions would be provided on the colour reference card.

In this embodiment, colour change dip test pad 12a is treated with a reagent designed to test for the presence of iron in the water. It is found that with a suitable colour reference scale 14a, the amount of iron present can be accurately assessed in most samples of central heating system water, irrespective of other contaminants which may be present.

The amount of iron present is an important test in itself, since dissolved iron in the system water is an indication that corrosion is taking place. However, the amount of iron present is also found to be important for correct assessment of the dip-test to determine molybdate level.

In this embodiment four of the colour reference scales shown on the card are used for assessment of the molybdate level, the colour reference scale used for assessment being chosen according to the level of iron assessed. For example, a first molybdate colour reference scale 14c is used where the iron level assessed is ≥0 ppm and <5 ppm, a second molybdate colour reference scale 14d is used where the iron level assessed is ≥5 ppm and <10 ppm, a third molybdate colour reference scale 14e is used where the iron level assessed is ≥10 ppm and <20 ppm, and a fourth molybdate colour reference scale 14f is used where the iron level assessed is ≥20 ppm. In this example, the colour reference scale 14b is used to assess the level of copper, based on another one of the dip test pads on the carrier 10.

Central heating system water can contain a wide range of different dissolved iron levels, and the invention allows for accurate testing to determine molybdate level, which is important to ensure a correct level of corrosion inhibitor, in many central heating systems, irrespective of iron contamination.

1-8. (canceled)

9. A method of testing central heating and/or cooling system water for a concentration of molybdate, the method comprising the steps of:
using a first colour-change dip test to test for a concentration of iron in the central heating and/or cooling system water, and comparing a colour of the first colour-change dip test to an iron testing reference to assess an iron concentration; and
using a second colour-change dip test to test for the concentration of molybdate in the central heating and/or cooling system water, and comparing a colour of the second colour-change dip test to a molybdate testing reference, and assessing a molybdate concentration based on the comparison of the second colour-change dip test to the molybdate testing reference and based on the assessed iron concentration;
wherein the molybdate testing reference comprises a plurality of colour reference scales, a colour reference scale being selected from the plurality of colour reference scales and used in an assessment of the molybdate concentration based on the assessed iron concentration; and
wherein the assessment is carried out by image processing software based on a photograph of the first and second colour-change dip tests alongside the plurality of colour reference scales.

10. The method of claim 9, wherein the first colour-change dip test and the second colour-change dip test are provided as first and second reagent-impregnated pads on a single carrier.

11. A method of claim 10, wherein an absorbent buffer pad is provided between the first and second reagent-impregnated pads.

12. The method of claim 9, wherein the iron testing reference and the molybdate testing reference are provided on a single reference card.

13. The method of claim 9, wherein the colour reference scale for the assessment of the molybdate concentration is selected based on the assessed iron concentration being one of: <5 ppm; ≥5 ppm and <10 ppm ; ≥10 ppm and <20 ppm; ≥20 ppm.

14. The method of claim 9, wherein the plurality of colour reference scales does not include numbers or other references, and the image processing software includes reference information allowing colour comparison for the assessment.

15. The method of claim 9. wherein the image processing software is adapted to acquire the photograph using a camera built into a device on which the image processing software is running.

16. A non-transient computer readable medium having instructions to be executed on a computer processor, the instructions including a method of testing central heating and/or cooling system water for a concentration of molybdate, the method comprising the steps of:
using a first colour-change dip test to test for a concentration of iron in the central heating and/or cooling system water, and comparing a colour of the first colour-change dip test to an iron testing reference to assess an iron concentration; and
using a second colour-change dip test to test for the concentration of molybdate in the central heating and/or cooling system water, and comparing a colour of the second colour-change dip test to a molybdate testing reference, and assessing a molybdate concentration based on the comparison of the second colour-change dip test to the molybdate testing reference and based on the assessed iron concentration;
wherein the molybdate testing reference comprises a plurality of colour reference scales, a colour reference scale being selected from the plurality of colour reference scales and used in an assessment of the molybdate concentration based on the assessed iron concentration; and
wherein the assessment is carried out by image processing software based on a photograph of the first and second colour-change dip tests alongside the plurality of colour reference scales.

17. The non-transient computer readable medium of claim 16, wherein the first colour-change dip test and the second colour-change dip test are provided as first and second reagent-impregnated pads on a single carrier.

18. A non-transient computer readable medium of claim 17, wherein an absorbent buffer pad is provided between the first and second reagent-impregnated pads.

19. The non-transient computer readable medium of claim 16, wherein the iron testing reference and the molybdate testing reference are provided on a single reference card.

20. The non-transient computer readable medium of claim 16, wherein the colour reference scale for the assessment of the molybdate concentration is selected based on the assessed iron concentration being one of: <5 ppm; ≥75 ppm and <10 ppm; ≥10 ppm and <20 ppm; ≥20 ppm.

21. The non-transient computer readable medium of claim 16, wherein the plurality of colour reference scales does not include numbers or other references, and the image processing software includes reference information allowing colour comparison for the assessment.

22. The non-transient computer readable medium of claim 16, wherein the image processing software is adapted to acquire the photograph using a camera built into a device on which the image processing software is running.
